(19) United States
(12) Patent Application Publication
(10) Pub. No.: US 2009/0285404 A1
(43) Pub. Date: Nov. 19, 2009

(54) ACOUSTIC CALIBRATION SOUND SYSTEM

(75) Inventors: Shou-Hsiu Hsu, Taipei (TW); Kuo-Hsun Huang, Taipei (TW); Fou-Ming Liou, Taipei (TW); Cheng-Hung Tsai, Taipei (TW)

Correspondence Address: KIRTON AND MCCONKIE, 60 EAST SOUTH TEMPLE,, SUITE 1800, SALT LAKE CITY, UT, 84111, US

(73) Assignee: ASUSTEK COMPUTER INC., Taipei (TW)

(21) Appl. No.: 12/436,312

(22) Filed: May 6, 2009

(30) Foreign Application Priority Data
May 15, 2008 (TW) 097117886

(51) Int. Cl. H04R 5/00; H04B 17/00

(52) U.S. Cl. 381/28; 367/13

(57) ABSTRACT

An acoustic calibration sound system includes a coordinate position detecting device and a host. The coordinate position detecting device is used for detecting a position of a listener in a space plane and issuing a corresponding position signal. The host outputs an audio signal. The host has an acoustic characteristic parameter matrix containing multiple acoustic characteristic parameters related to multiple positions in the space plane. The host selects a corresponding acoustic characteristic parameter in response to the position signal. According to the selected acoustic characteristic parameter, the host adjusts the audio signal.

### FIELD OF THE INVENTION

The present invention relates to an acoustic calibration sound system, and more particularly to an acoustic calibration sound system having a coordinate position detecting device.

### BACKGROUND OF THE INVENTION

FIG. 1 is a schematic functional block diagram illustrating a conventional sound system. As shown in FIG. 1, the sound system principally comprises an audio source system 11, an amplifier system 13 and a speaker system 15. The amplifier system 13 comprises a pre-amplifier 131 and a power amplifier 133. The audio source system 11 and the amplifier system 13 may be collectively referred as host 17.

The audio source system 11 is an acoustic device capable of converting sound energy into electronic signals or replaying the recorded audio signals. The audio source system 11 includes for example an AM/FM tuner for receiving broadcast programs, record/playback tape deck for playing cassettes, a laser turntable for playing compact discs, a microphone, a VCD/DVD player, and so on.

Hereinafter, the operations of the sound system will be illustrated with reference to FIG. 1. First of all, the audio source system 11 generates a first signal (e.g. a weak signal) to the pre-amplifier 131. By the pre-amplifier 131, the first signal is amplified into a second signal (e.g. a small signal). The second signal is transmitted to the power amplifier 133. Since the second signal is an audio signal, the characteristics of the audio signal (e.g. the frequency or the level of the audio signal) are altered by the pre-amplifier 131 in order to reduce the interference from noise. After the second signal is received by the power amplifier 133, the power of the second signal is amplified to output a third signal for driving the speaker system 15. By the speaker system 15, the third signal is transformed into acoustic wave vibration to be outputted.

In the early stage, mono channel sound systems were used. Recently, with rapid development of the sound systems, dual-channel stereo sound systems have been disclosed. Moreover, multi-channel surround sound systems (e.g. 5.1 multi-channel surround sound systems) encompass a range of techniques for enriching the sound reproduction quality.

FIG. 2A is a schematic functional block diagram illustrating a multi-channel sound system, in which the listener is located at a central position. The multi-channel sound system comprises a host 21 and a speaker system. The host 21 comprises an audio source system 211 and an amplifier system 213. The speaker system comprises a left channel speaker 23 and a right channel speaker 25. Generally, the sound field surrounding the listener 27 is dependent on the attributes of the sound system and the locations and the angles of the left channel speaker 23 and the right channel speaker 25 relative to the listener 27. For installing the multi-channel sound system, the locations and the angles of the left channel speaker 23 and the right channel speaker 25 relative to the listener 27 should be taken into consideration. As such, a proper acoustic characteristic parameter is obtained. According to the acoustic characteristic parameter, the sound reproduction quality is enhanced.

Generally, the acoustic characteristic parameter is obtained in the situation that the listener 27 is located at a central position along the centerline between the left channel speaker 23 and a right channel speaker 25. In other words, if the listener 27 is located at a central position as shown in FIG. 2A, the acoustic effect heard by the listener 27 is optimal.

On the other hand, if the listener 27 is deviated from the central position, the sound field is readily distorted. As shown in FIG. 2B, the listener 27 is deviated from the central position of the multi-channel sound system. Since the listener 27 is closer to the left channel speaker 23 than the right channel speaker 25, the listener 27 may feel that the sound level from the left channel speaker 23 is higher than that from the right channel speaker 25 if the original acoustic characteristic parameter is used to control the left channel speaker 23 and the right channel speaker 25. In addition, the listener 27 may feel that the sound from the right channel speaker 25 is delayed with respect to the sound from the left channel speaker 23. In order to have the listener 27 hear the best acoustic effect, an additional acoustic calibration process needs to be performed to acquire a new acoustic characteristic parameter.

Recently, an acoustic calibration sound system has been proposed, such that the listener can hear sound with a good acoustic effect at any position. FIG. 3 is a schematic functional block diagram illustrating a conventional acoustic calibration sound system. The acoustic calibration sound system uses a microphone to implement acoustic calibration. As shown in FIG. 3, the acoustic calibration sound system comprises a host 31, a speaker system and a test microphone 37. The host 31 comprises an audio source system 311, an amplifier system 313 and a micro-controller 315. The speaker system comprises a left channel speaker 33 and a right channel speaker 35. The test microphone 37 is an omni-directional microphone. Hereinafter, a process of adjusting the acoustic characteristic parameter when the position of the listener is altered will be illustrated in more details. First of all, the test microphone 37 is turned on by the listener and the test microphone 37 is located at the position of the listener. Then, an exclusive test disc offered by the manufacture of the acoustic calibration sound system is loaded into the host 31, wherein the test disc contains the test tones of various acoustic characteristic parameters. Then, the left channel speaker 33 and the right channel speaker 35 output test tones to the test microphone 37. After the test tones are received by the test microphone 37, the test tones are transmitted to the micro-controller 315 of the host 31. According to the received test tones, the micro-controller 315 calculates the acoustic characteristic parameter at the position of the test microphone 37. According to the acoustic characteristic parameter, the micro-controller 315 adjusts the delay time between the left channel speaker 33 and the right channel speaker 35 and the sound levels of the left channel speaker 33 and the right channel speaker 35. Consequently, the listener can hear sound with a good acoustic effect at the position of the test microphone 37.

The acoustic calibration sound system mentioned above, however, still has some drawbacks. For example, the use of the manual acoustic calibration process to acquire the new acoustic characteristic parameter is time-consuming and troublesome. For most multi-channel acoustic calibration sound system, the acoustic calibration process is performed to obtain an initial acoustic characteristic parameter immediately after the sound system is installed. The initial acoustic characteristic parameter is then stored in the host 31. Since the manual acoustic calibration process is time-consuming and troublesome, almost no acoustic calibration process will be done from then on.

### SUMMARY OF THE INVENTION

In accordance with an aspect of the present invention, there is provided an acoustic calibration sound system. The acoustic calibration sound system includes a coordinate position detecting device and a host. The coordinate position detecting device is used for detecting a position of a listener in a space plane and issuing a corresponding position signal. The host outputs an audio signal. The host has an acoustic characteristic parameter matrix containing multiple acoustic characteristic parameters related to multiple positions in the space plane. The host selects a corresponding acoustic characteristic parameter in response to the position signal. According to the selected acoustic characteristic parameter, the host adjusts the audio signal.

In accordance with another aspect of the present invention, there is provided an acoustic calibration method for use in a sound system. The acoustic calibration method includes steps of detecting a position of a listener in a space plane and issuing a corresponding position signal, selecting a corresponding acoustic characteristic parameter from an acoustic characteristic parameter matrix in response to the position signal, and adjusting an audio signal according to the selected acoustic characteristic parameter.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic functional block diagram illustrating a conventional sound system;

FIG. 2A is a schematic functional block diagram illustrating a multi-channel sound system, in which the listener is located at a central position;

FIG. 2B is a schematic functional block diagram illustrating a multi-channel sound system, in which the listener is deviated from the central position;

FIG. 3 is a schematic functional block diagram illustrating a conventional acoustic calibration sound system;

FIG. 4 is a schematic functional block diagram illustrating an acoustic calibration sound system according to a preferred embodiment of the present invention; and

FIG. 5 is a flowchart illustrating an acoustic calibration method of the present invention.

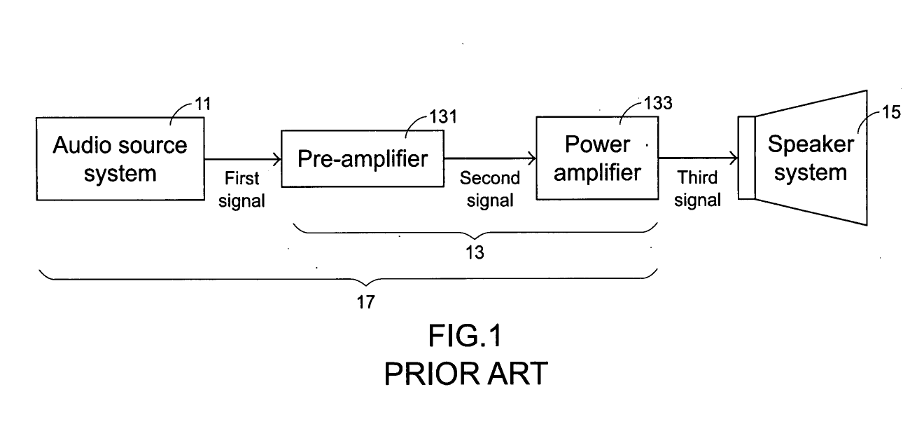

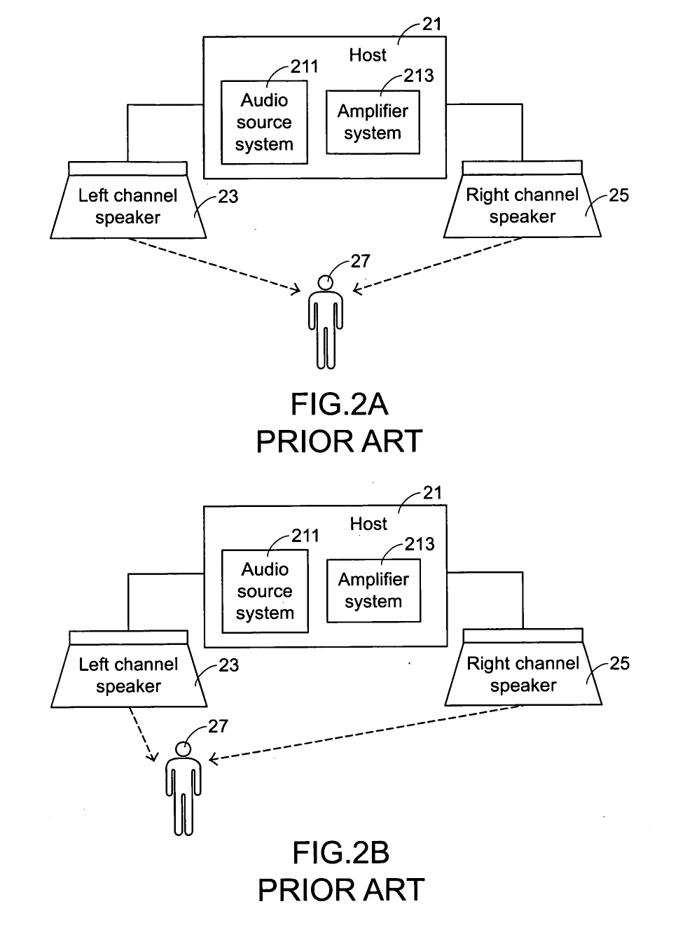

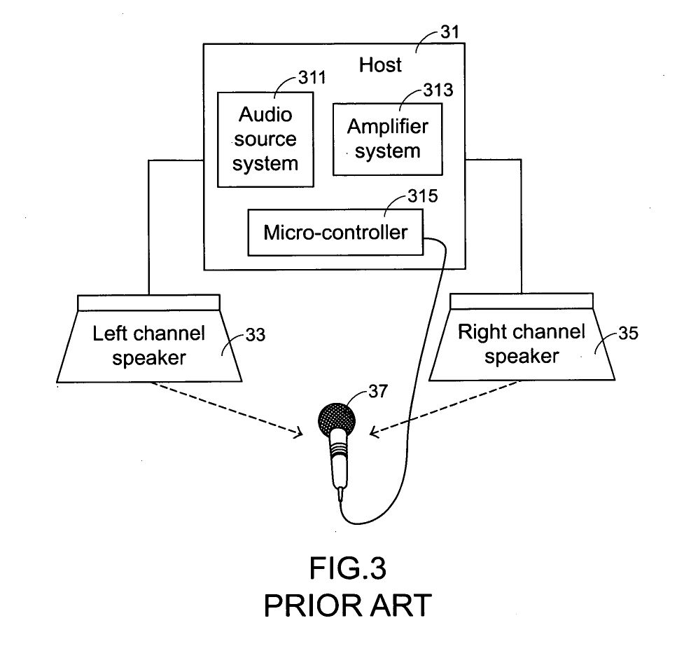

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

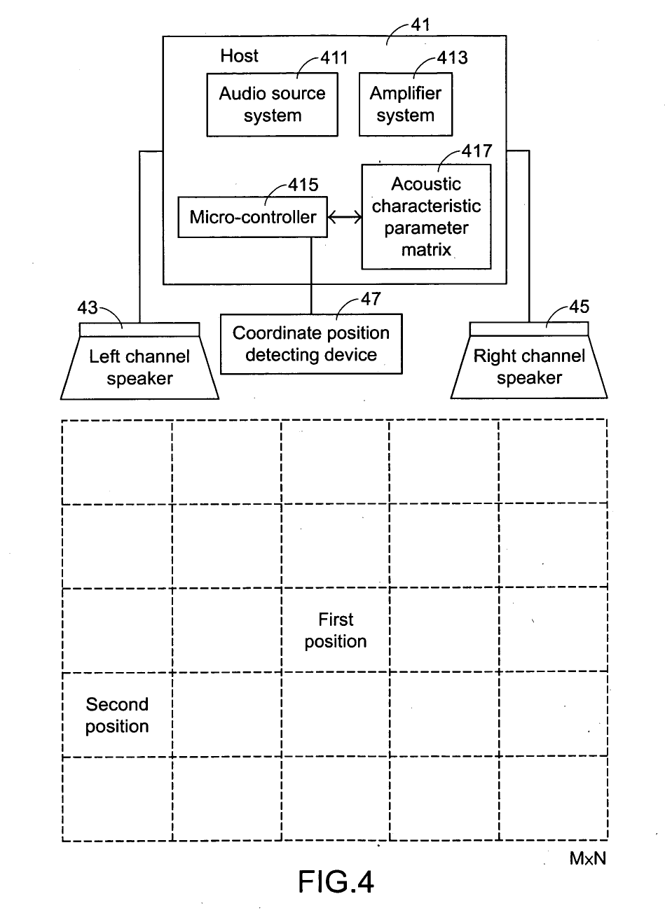

FIG. 4 is a schematic functional block diagram illustrating an acoustic calibration sound system according to a preferred embodiment of the present invention. As shown in FIG. 4, the acoustic calibration sound system principally comprises a host 41, a speaker system and a coordinate position detecting device 47. The host 41 comprises an audio source system 411, an amplifier system 413, a micro-controller 415 and an acoustic characteristic parameter matrix 417. The speaker system comprises a left channel speaker 43 and a right channel speaker 45. The coordinate position detecting device 47 is communicated with the host 41 for detecting the position of the listener and issuing a corresponding position signal. The acoustic characteristic parameter matrix 417 has been stored in the host 41. An example of the acoustic characteristic parameter matrix 417 is a memory storing a plurality of acoustic characteristic parameters related to various positions of the acoustic calibration sound system on the space plane. In a case that the space plane of the acoustic calibration sound system is divided as an M-by-N matrix, a corresponding acoustic characteristic parameter matrix having an order of M×N is stored in the host 41. The acoustic characteristic parameter matrix contains M×N counts of acoustic characteristic parameters obtained at various positions. In other words, the space plane includes a two-dimensional matrix corresponding to the acoustic characteristic parameter matrix.

For example, if the previous acoustic characteristic parameter is associated with a first position (that is, the listener is located at the first position of the space plane), the host 41 is set according to the acoustic characteristic parameter obtained at the first position. Consequently, the listener at the first position may feel that the output sounds of the left channel speaker 43 and the right channel speaker 45 have the best acoustic effect.

On the other hand, if the listener is moved from the first position to a second position, the listener at the second position fails to hear sound with a good acoustic effect by the acoustic characteristic parameter obtained at the first position. That is, it is necessary to calibrate the acoustic characteristic parameter of the sound system in order to hear sound with a good acoustic effect. For calibrating the acoustic characteristic parameter, the new position of the listener (e.g. the second position) is detected by the coordinate position detecting device 47 and a position signal indicative of the new position is transmitted to the host 41. After the position signal is received by the host 41, the micro-controller 415 of the host 41 will acquire a new acoustic characteristic parameter corresponding to the new position according to the position signal and the acoustic characteristic parameter matrix. According to the new acoustic characteristic parameter, the micro-controller 415 adjusts the delay time between the left channel speaker 43 and the right channel speaker 45 and the sound levels of the left channel speaker 43 and the right channel speaker 45. Consequently, the listener can hear sound with a good acoustic effect at the new position.

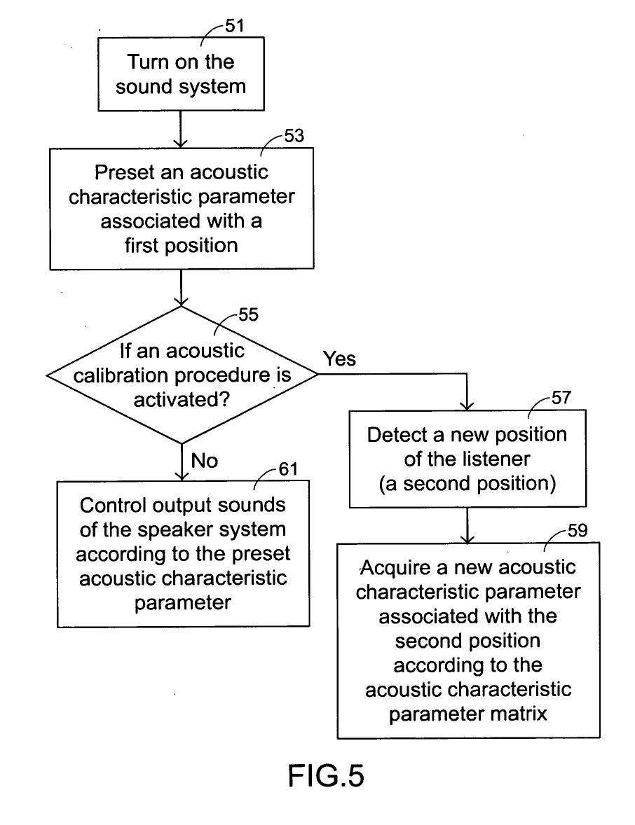

FIG. 5 is a flowchart illustrating an acoustic calibration method of the present invention. First of all, the sound system of the present invention is turned on (Step 51). Meanwhile, the previous acoustic characteristic parameter associated with a first position is used as a preset acoustic characteristic parameter (Step 53). Next, the listener may determine whether an acoustic calibration procedure is activated (Step 55). If the listener is located at the first position and thus the acoustic calibration procedure is not necessary at this moment, the sound system will control output sounds of the speaker system according to the preset acoustic characteristic parameter associated with the first position (Step 61). Otherwise, if the listener is not located at the first position and thus the listener decides to activate the acoustic calibration procedure, the new position of the listener (e.g. the second position) is detected by the coordinate position detecting device and a position signal indicative of the new position is transmitted to the host (Step 57). After the position signal indicative of the new position is received by the host, the micro-controller of the host will acquire a new acoustic characteristic parameter associated with the new position according to the acoustic characteristic parameter matrix (Step 59). Meanwhile, the sound system will control output sounds of the speaker system according to the new acoustic characteristic parameter associated with the second position.

In some embodiments, the coordinate position detecting device used in the present invention is an optical device including multiple infrared transceivers. When the listener enters the sensing range of an infrared transceiver and the acoustic calibration procedure is activated, an infrared beam emitted by the infrared transceiver is reflected by the listener and the reflected beam is received by the receiver of the infrared transceiver. By comparing the intensity of the original infrared beam with the intensity of the reflected infrared beam, the coordinate position detecting device can realize the position of the listener.

In some embodiments, the coordinate position detecting device used in the present invention includes multiple ultrasonic transceivers, which are usually applied to liquid level control systems or back car radar systems. When the listener enters the sensing range of an ultrasonic transceiver, an ultrasonic signal emitted by the ultrasonic transceiver is reflected by the listener and the reflected ultrasonic signal (or an echo signal) is then transmitted to a receiver of the ultrasonic transceiver. Upon receipt of the echo signal, the time of flight (TOF) of the ultrasonic signal is measured. In the context, the time of the ultrasonic signal emitted from the ultrasonic transceiver and reflected by the object to reach the receiver of the ultrasonic transceiver is referred as the time of flight (TOF). For estimating the distance between the listener and the ultrasonic transceiver, the speed of sound in air may be multiplied by TOF and then divided by 2. When the acoustic calibration procedure is activated, the ultrasonic transceivers can detect the position of the listener, thereby implementing the acoustic calibration process.

Alternatively, the coordinate position detecting device used in the present invention is an image pickup device such as a camera. When the listener enters the sensing range of the image pickup device and the acoustic calibration procedure is activated, the position of the listener is located by comparing the image including the listener with the image excluding the listener.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An acoustic calibration sound system comprising:
a coordinate position detecting device for detecting a position of a listener in a space plane and issuing a corresponding position signal; and
a host outputting an audio signal and having an acoustic characteristic parameter matrix containing multiple acoustic characteristic parameters related to multiple positions in the space plane, wherein the host selects a corresponding acoustic characteristic parameter in response to the position signal, and the host adjusts the audio signal according to the selected acoustic characteristic parameter.

2. The acoustic calibration sound system according to claim 1 wherein the host further comprises an audio source system for generating the audio signal.

3. The acoustic calibration sound system according to claim 2 wherein the host further comprises a micro-controller communicated with the coordinate position detecting device and the acoustic characteristic parameter matrix, wherein the micro-controller adjusts the audio signal according to the selected acoustic characteristic parameter.

4. The acoustic calibration sound system according to claim 2 wherein the host further comprises an amplifier system, which is connected to the audio source system for receiving the audio signal.

5. The acoustic calibration sound system according to claim 1 wherein the host is further connected to a speaker system and the audio signal adjusted by the host is transmitted to the speaker system.

6. The acoustic calibration sound system according to claim 1 wherein the coordinate position detecting device includes multiple infrared transceivers.

7. The acoustic calibration sound system according to claim 1 wherein the coordinate position detecting device includes multiple ultrasonic transceivers.

8. The acoustic calibration sound system according to claim 1 wherein the coordinate position detecting device is an image pickup device.

9. The acoustic calibration sound system according to claim 1 wherein the space plane includes a two-dimensional matrix corresponding to the acoustic characteristic parameter matrix.

10. The acoustic calibration sound system according to claim 1 wherein a delay time of outputting the audio signal or a sound level of the audio signal according to the selected acoustic characteristic parameter.

11. An acoustic calibration method for use in a sound system, the acoustic calibration method comprising steps of:
detecting a position of a listener in a space plane and issuing a corresponding position signal;
selecting a corresponding acoustic characteristic parameter from an acoustic characteristic parameter matrix in response to the position signal; and
adjusting an audio signal according to the selected acoustic characteristic parameter.

12. The acoustic calibration method according to claim 11 wherein the position of the listener in the space plane is detected by a coordinate position detecting device including multiple infrared transceivers.

13. The acoustic calibration method according to claim 11 wherein the position of the listener in the space plane is detected by a coordinate position detecting device including multiple ultrasonic transceivers.

14. The acoustic calibration method according to claim 11 wherein the position of the listener in the space plane is detected by a coordinate position detecting device including an image pickup device.

15. The acoustic calibration method according to claim 11 further comprising a step of outputting the audio signal to a speaker system.

16. The acoustic calibration method according to claim 11 wherein the space plane includes a two-dimensional matrix corresponding to the acoustic characteristic parameter matrix.

17. The acoustic calibration method according to claim 11 wherein a delay time of outputting the audio signal or a sound level of the audio signal according to the selected acoustic characteristic parameter.
